(19) United States
(12) Patent Application Publication
(10) Pub. No.: US 2007/0059993 A1
(43) Pub. Date: Mar. 15, 2007

(54) Signal line socket

(75) Inventors: Dwo Chen, Taoyuan Hsien (TW); Jay Yue, Taoyuan Hsien (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Delta Electronics, Inc.

(21) Appl. No.: 11/321,205

(22) Filed: Dec. 29, 2005

(30) Foreign Application Priority Data
Sep. 15, 2005 (TW) 094131896

(51) Int. Cl. H01R 13/11

(52) U.S. Cl. 439/857

(57) ABSTRACT

A signal line socket disposed on a test circuit board for receiving a signal line is disclosed. The signal line socket includes a main body disposed on the test circuit board and having an accommodating space, a first conductive component disposed inside the accommodating space, a second conductive component disposed inside the accommodating space and being opposite to the first conductive component, and a securing element electrically connected to the test circuit board and fixing the first and second conductive components inside the accommodating space of the main body. A clearance is formed between the first and second conductive components for receiving the signal line and allowing the signal line against the first and second conductive components, thereby transmitting a signal from the signal line to the test circuit board through the first and second conductive components and the securing element.

### FIELD OF THE INVENTION

The present invention relates to a socket, and more particularly to a signal line socket adapted to a test circuit board.

### BACKGROUND OF THE INVENTION

Along with electronic industry development, the circuit design of electronic product becomes more complicated. For assuring the function of produced circuit has the same function as the original design one, it is important to have an accurate test fixture of circuit board to achieve the fast testing.

Generally, the testing method is as the following. First of all, plural test points of a tested circuit board are connected to a plural of signal lines, respectively. Subsequently, the signal lines are inserted into a signal line socket of a test circuit board for electrically connecting the signal lines to the test circuit board and transferring the signal from the tested circuit board to the test circuit board. Then, the test is performed to determine whether the tested circuit board is operated normally or not.

Please refer to FIG. 1 which is a diagram illustrating a conventional signal line socket of a test circuit board. As shown in FIG. 1, a signal line socket 11 is disposed on a test circuit board 12 and electrically connected thereto. The signal line socket 11 has a plurality of openings 111 and a plurality of buttons 112. Furthermore, the plural openings 111 are corresponding to the plural buttons 112, respectively. The openings 111 are disposed at the lateral side of the signal line socket 11 for respectively receiving a plurality of signal lines 13 of a tested circuit board (not shown in FIG. 1). When the signal lines 13 are inserted into the corresponding openings 111 of the signal line socket 11, respectively, each of the signal lines 13 is tightly clipped by a corresponding receiving element (not shown in FIG. 1) inside the signal line socket 11 in order to proceed the testing. After the testing, the operator has to push the corresponding buttons 112 to relieve the signal lines 13 from the signal line socket 11. In other words, each of the signal lines 13 is disconnected to the corresponding receiving element of the signal line socket 11.

Certainly, the signal line socket 11 can achieve the electrical connection function between the signal line 13 and the test circuit board 12. However, the operator has to push the buttons 112 of the signal line socket 11 to relieve the signal lines 13 one by one after testing. It causes operation inconveniently, especially when the tested circuit board needs to be connected to more than one set signal lines for testing. Since it is time consumption, the yield is hard to be increased. In addition, the structure design of the buttons 112 and the receiving elements of the signal line socket 11 must appropriately cooperate each other for smoothly inserting and relieving the signal lines 13. It is not only complicated structure and difficult assembly but also higher cost.

Therefore, the purpose of the present invention is to develop a signal line socket to deal with the above situations encountered in the prior art.

### SUMMARY OF THE INVENTION

An object of the present invention is to provide a signal line socket for efficiently testing, easily operating and time-saving.

Another object of the present invention is to provide a signal line socket for easily assembly and cost-saving.

According to an aspect of the present invention, there is provided a signal line socket disposed on a test circuit board for receiving a signal line. The signal line socket includes a main body disposed on the test circuit board and having an accommodating space, a first conductive component disposed inside the accommodating space, a second conductive component disposed inside the accommodating space and being opposite to the first conductive component, and a securing element electrically connected to the test circuit board and fixing the first and second conductive components inside the accommodating space of the main body. A clearance is formed between the first and second conductive components for receiving the signal line and allowing the signal line against the first and second conductive components, thereby transmitting a signal from the signal line to the test circuit board through the first and second conductive components and the securing element.

Preferably, the first and second conductive components are integrally formed. Preferably, the signal line socket further includes a connection component connected to the first and second conductive components. Preferably, the connection component has a hole and the main body has an opening under the accommodating space.

For example, the securing element comprises a screw and a nut, the screw is contacted to the first and second conductive components, passed through the hole of the connection component and the opening under the accommodating space, and fixed to the test circuit board by the nut.

For example, the securing element comprises a screw, the screw is contacted to the first and second conductive components, passed through the hole of the connection component and the opening under the accommodating space, and fixed to the test circuit board by soldering.

Preferably, the first and second conductive components comprise winding portions, respectively, for contacting and against the signal line.

Preferably, the first and second conductive components are against two opposite lateral sides of the accommodating space of the main body, respectively.

Certainly, the signal line is electrically connected to a tested circuit board.

Preferably, the signal line socket further includes a cover disposed on the main body and having an opening. The opening is used for guiding the signal line to insert into the clearance to allow the signal line against the first and second conductive components.

According to another aspect of the present invention, there is provided a signal line socket disposed on a test circuit board for receiving a plurality of signal lines. The signal line socket includes a main body disposed on the test circuit board and having a plurality of accommodating spaces, a plurality of first conductive components disposed inside the accommodating spaces, respectively, a plurality of second conductive components disposed inside the accommodating spaces and being opposite to the first conductive components, respectively, and a plurality of securing elements electrically connected to the test circuit board, respectively, and fixing the first and second conductive components inside the accommodating spaces of the main body, respectively. In each of the accommodating spaces of the main body, a clearance is formed between the first conductive component and the second conductive component for receiving the signal line and allowing the signal line against the first and second conductive components.

### BRIEF DESCRIPTION OF THE DRAWINGS

The present invention may best be understood through the following description with reference to the accompanying drawings, in which:

FIG. 1 is a diagram illustrating a structure of a conventional signal line socket adapted to a test circuit board;

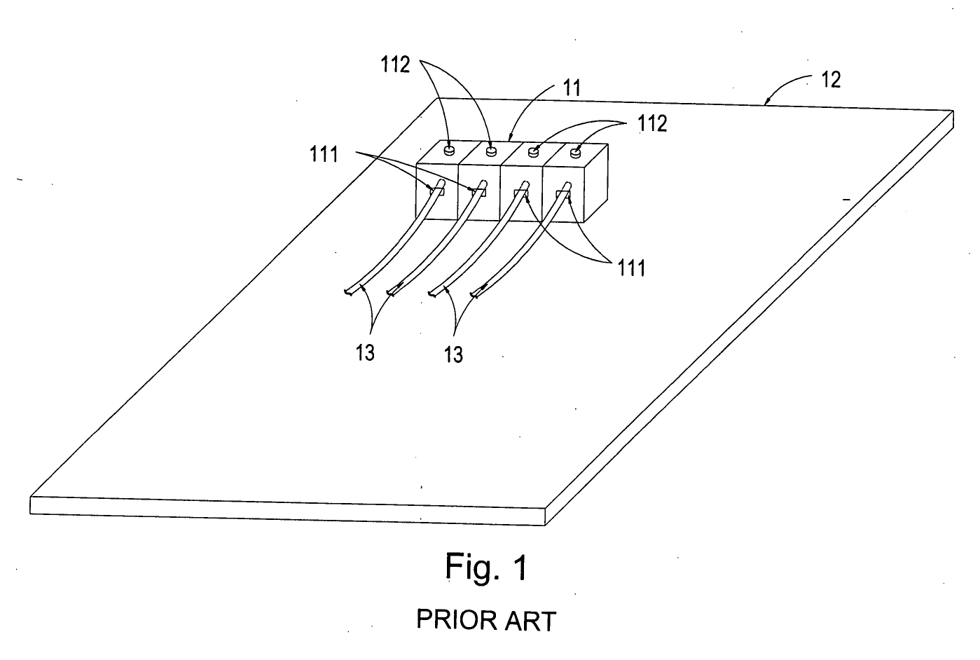

FIG. 2 is an exploded perspective diagram illustrating a structure of a signal line socket according to a preferred embodiment of the present invention;

FIG. 3 is an assembly diagram illustrating a structure of FIG. 2;

FIG. 4 is an A-A′ line cross-sectional diagram illustrating a structure of FIG. 3;

FIG. 5 is a diagram illustrating a structure of a signal line socket according to another preferred embodiment of the present invention; and

FIG. 6 is a lateral cross-sectional diagram illustrating an assembly structure of FIG. 5.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

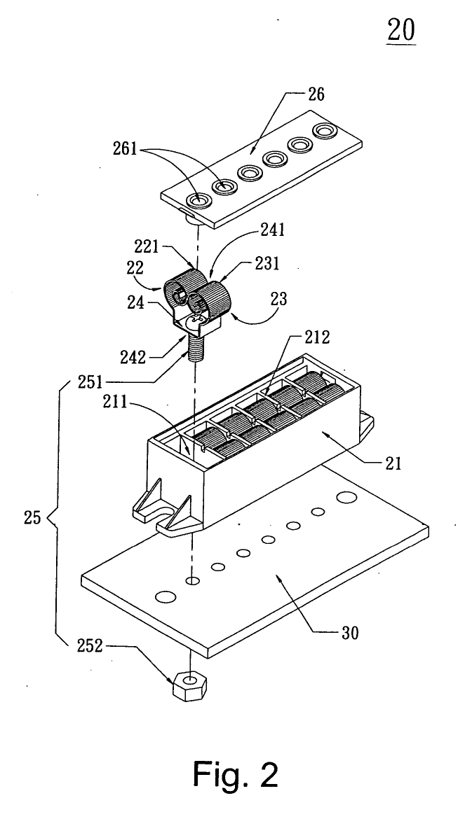

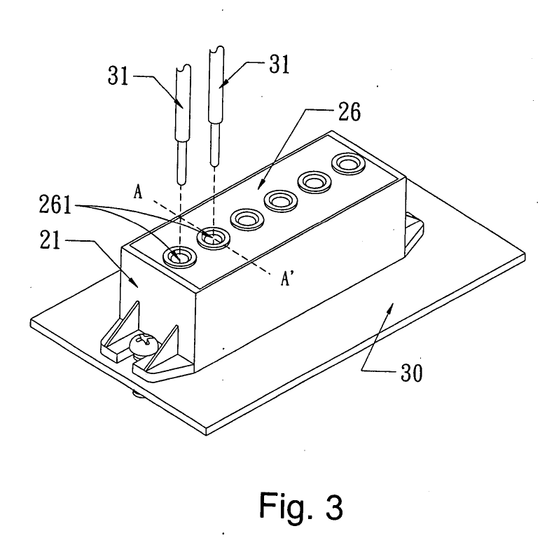

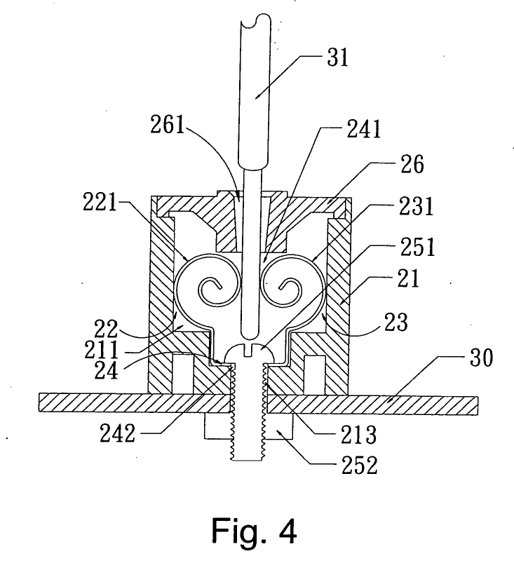

Please refer to FIG. 2 which is an exploded diagram illustrating a structure of a signal line socket according to a preferred embodiment of the present invention. FIG. 3 is an assembly diagram illustrating a structure of FIG. 2 and FIG. 4 is an A-A′ line cross-sectional diagram illustrating a structure of FIG. 3. As shown in FIG. 2, a signal line socket 20 can be inserted by a plurality of signal lines simultaneously. For easily describing, a signal line set is used as an example to explain the present invention. The signal line socket 20 comprises a main body 21, a first conductive component 22, a second conductive component 23, a securing element 25 and a cover 26. The signal line socket 20 is disposed on a test circuit board 30 for electrically connecting a signal line 31 (as shown in FIG. 3) of a tested circuit board (not shown in FIGS. 2, 3 and 4). When the signal line 31 is electrically connected to the circuit of the test circuit board 30 via the signal line socket 20, the signal of the tested circuit board is transmitted to the test circuit board 30 for testing so as to determine whether the tested circuit board is operating normally.

Please refer to FIG. 2. The main body 21 is a rectangular solid structure in this embodiment. The space inside the main body 21 is separated into a plurality of accommodating spaces 211 by a plurality of partitions 212, respectively. The bottom of each accommodating space 211 has an opening 213 as shown in FIG. 4. Furthermore, the first and second conductive components 22 and 23 are disposed in the same accommodating space 211 of the main body 21 so that the first conductive component 22 is against one lateral side of the accommodating space 211 of the main body 21 and the second conductive component 23 is against the other lateral side of the accommodating space 211 of the main body 21. The first and second conductive components 22 and 23 comprise winding portions 221 and 231, respectively. As shown in FIGS. 2 and 4, the winding portions 221 and 231 are disposed opposite inside the accommodating space 211. A clearance 241 is formed between the winding portions 221 and 231. When the signal line 31 is inserted into the clearance 241 for testing, the winding portions 221 and 231 are against the signal line 31 and contact thereto, respectively. Because of the elasticity of the winding portions 221 and 231, the signal line 31 not only can be tightly clipped by the winding portions 221 and 231 but also can be easily pulled out the clearance 241 after testing.

As shown in FIG. 2, the first and second conductive components 22 and 23 are integrally formed. For example, a long metal strip is folded to three portions, wherein two end portions become the first and second conductive components 22 and 23 and the ends are cured to form the winding portions 221 and 231. The middle portion is a connection component 24 for connecting the first and the second conductive components 22 and 23. Furthermore, the connection component 24 have a hole 242 disposed at middle site.

Please refer to FIGS. 2 and 4. The securing element 25 is used for fixing the signal line socket 20 to the test circuit board 30 and electrically connecting thereto. The securing element 25 comprises a screw 251 and a nut 252. As shown in FIG. 4, the screw 251 is orderly passed through the hole 242 of the connection component 24, the opening 213 of the main body 21 at the bottom of the accommodating space 211 and a hole of the test circuit board 30. Sequentially, the screw 251 is engaged to the nut 252 for fastening the first and second conductive components 22 and 23 to the internal of the accommodating space 211 of the main body 21. Besides the fastening function, the securing element 25 has another function for electrically connecting the first and second conductive components 22 and 23 to the test circuit board 30 by the screw 251.

Please refer to FIG. 3. The cover 26 is matched the main body 21 for covering the accommodating spaces 211 of the main body 21 and protecting the first and second conductive components 22 and 23. In addition, the cover 26 has a plurality of openings 261, each of which is used for guiding the signal line 31 to insert the clearance 241 between the first and second conductive components 22 and 23 and contact thereto. As shown in FIG. 4, since the opening 261 of the cover 26 is corresponding to the clearance 241 between the winding portions 221 and 231, the signal line 31 is against and contacts to the winding portions 221 and 231 when being inserted into the opening 261. Simultaneously, the signal line 31 is tightly clipped by the winding portions 221 and 231 from both sides due to the counterforce from the both lateral walls of the main body 21, for electrically connecting to the first and second conductive components 22 and 23. Thus, the signal from the signal line 31 is transmitted to the test circuit board 30 by the first and second conductive components 22 and 23 and the screw 251 for proceeding the circuit testing. After testing, the signal line 31 is easily and quickly pulled out from the clearance 241 of the signal line socket 20. Hence, it is time-saving. In addition, as shown in FIG. 3, the main body 21 can be fixed on the test circuit board 30 by screwing.

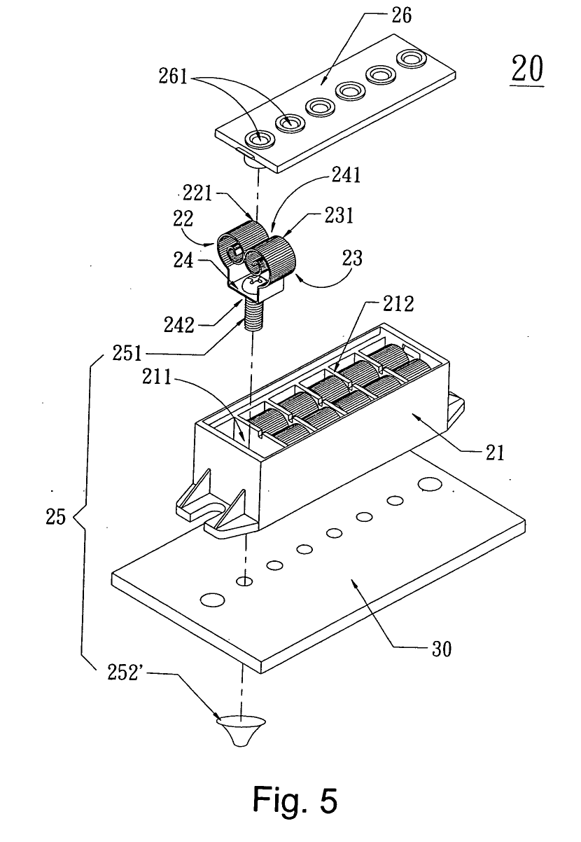

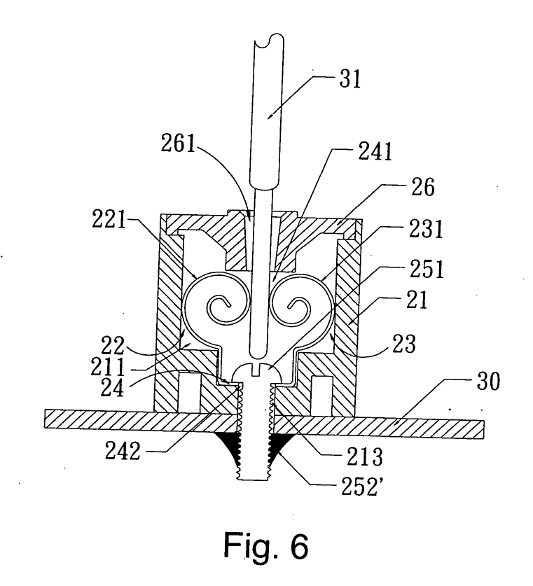

Please refer to FIG. 5 which is a diagram illustrating a structure of a signal line socket according to another preferred embodiment of the present invention. FIG. 6 is a lateral cross-sectional diagram illustrating an assembly structure of FIG. 5. As shown in FIG. 5, the structure and function of the main body 21, the first and second conductive components 22 and 23 are similar to those in FIG. 2 except that a securing element 25 includes a screw 251 and a solder 252′. In other words, the screw 251 is orderly passed through the hole 242 of the connection component 24, the opening 213 of the main body 21 at the bottom of the accommodating space 211 and a hole of the test circuit board 30. Sequentially, the screw 251 is fixed to the test circuit board 30 by soldering.

Certainly, the securing element 25 can be any element which is able to fix the first and second conductive components 22 and 23 into the accommodating space 211 of the main body 21 and electrically connect the first and second conductive components 22 and 23 to the test circuit board 30. In addition, the first and second conductive components 22 and 23 can be formed separately, that is, they are two independent components.

To sum up, the signal line socket of the present invention provides the clearance between the first and second conductive components for allowing the signal line to be inserted. Furthermore, the two lateral walls of the main body provide the counterforce by the winding portions of the first and second conductive components for clipping the signal line. Thus, the signal line is electrically connected to the test circuit board by the first and second conductive components and the securing element for proceeding the testing. After testing, the signal line can be easily and quickly pulled out from the signal line socket of the present invention. It is time-saving. In addition, the signal line socket of the present invention has the advantages such as simple structure, easy assembly and low manufacture cost.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A signal line socket disposed on a test circuit board for receiving a signal line, comprising:
a main body disposed on said test circuit board and having an accommodating space;
a first conductive component disposed inside said accommodating space;
a second conductive component disposed inside said accommodating space and being opposite to said first conductive component; and
a securing element electrically connected to said test circuit board and fixing said first and second conductive components inside said accommodating space of said main body;
wherein a clearance is formed between said first and second conductive components for receiving said signal line and allowing said signal line against said first and second conductive components, thereby transmitting a signal from said signal line to said test circuit board through said first and second conductive components and said securing element.

2. The signal line socket according to claim 1 wherein said first and second conductive components are integrally formed.

3. The signal line socket according to claim 2 further comprising a connection component connected to said first and second conductive components.

4. The signal line socket according to claim 3 wherein said connection component has a hole and said main body has an opening under said accommodating space.

5. The signal line socket according to claim 4 wherein said securing element comprises a screw and a nut, said screw is contacted to said first and second conductive components, passed through said hole of connection component and said opening under said accommodating space, and fixed to said test circuit board by said nut.

6. The signal line socket according to claim 4 wherein said securing element comprises a screw, said screw is contacted to said first and second conductive components, passed through said hole of connection component and said opening under said accommodating space, and fixed to said test circuit board by soldering.

7. The signal line socket according to claim 1 wherein said first and second conductive components comprise winding portions, respectively, for contacting and against said signal line.

8. The signal line socket according to claim 1 wherein said first conductive component is against one lateral side of said accommodating space of said main body and said second conductive component is against the other lateral side of said accommodating space of said main body.

9. The signal line socket according to claim 1 wherein said signal line is electrically connected to a tested circuit board.

10. The signal line socket according to claim 1 further comprising a cover disposed on said main body and having an opening, wherein said opening is used for guiding said signal line to insert into said clearance and allowing said signal line against said first and second conductive components.

11. A signal line socket disposed on a test circuit board for receiving a plurality of signal lines, comprising:
a main body disposed on said test circuit board and having a plurality of accommodating spaces;
a plurality of first conductive components disposed inside said accommodating spaces, respectively;
a plurality of second conductive components disposed inside accommodating spaces and being opposite to said first conductive components, respectively; and
a plurality of securing elements electrically connected to said test circuit board, respectively, and fixing said first and second conductive components inside said accommodating spaces of said main body, respectively;
wherein in each of said accommodating spaces of said main body, a clearance is formed between said first conductive component and said second conductive component for receiving said signal line and allowing said signal line against said first and second conductive components.
